(19) United States
(12) Patent Application Publication
(10) Pub. No.: US 2011/0121576 A1
(43) Pub. Date: May 26, 2011

(54) MULTISTAGE ELECTRIC POWER GENERATING AND VENTILATING DEVICE

(76) Inventor: John W. Bayko, Sugar Land, TX (US)

(21) Appl. No.: 12/900,804

(22) Filed: Oct. 8, 2010

Related U.S. Application Data
(60) Provisional application No. 61/261,467, filed on Nov. 16, 2009.

(51) Int. Cl. F03D 9/00; H02K 16/00

(52) U.S. Cl. 290/55; 310/114

(57) ABSTRACT

An electric generator include a plurality of magnet disks coupled to a rotating shaft at longitudinally spaced apart locations. The magnet discs are formed on each face of a substantially flat, cylindrical rotor from magnetic material and are polarized in a selected direction. A plurality of stators is disposed between pairs of the magnet discs. A wire coil is disposed in each stator. In one aspect, a wind driven turbine rotates the generator.

### CROSS-REFERENCE TO RELATED APPLICATIONS

Priority is claimed from U.S. Provisional Application No. 61/261,467 filed on Nov. 16, 2009.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

This invention is related to the technical field of electric power generation. More particularly, this invention is in the technical field of alternative energy electricity generation and ventilation. More particularly, the present invention is in the technical field of alternative energy vertical axis turbine electricity generation.

2. Background Art

Current wind turbine electric power generation products are expensive, bulky and tall, and not suited for use in urban residential and commercial applications. There exists a need for more compact and inexpensive wind powered electric generating devices suitable for use with residences.

### SUMMARY OF THE INVENTION

An electric generator according to one aspect of the invention includes a plurality of magnet disks coupled to a rotating shaft at longitudinally spaced apart locations. The magnet discs are formed on each face of a substantially flat, cylindrical rotor from magnetic material and are polarized in a selected pattern. A plurality of stators is disposed between pairs of the magnet discs. A wire coil is disposed in each stator. In one aspect, a wind driven turbine rotates the generator.

The present invention in another aspect is a wind turbine operated electric generator and ventilator system that is unique in that it is low torque, which means the turbine starts rotating with little wind, and has a low RPM generator, resulting in high energy output. It provides continuous constant ventilation even in zero or low wind conditions using grid power by use of an electric motor that is switched on when the turbine speed falls below a selected threshold.

The electrical generating turbine in some examples can have a low, aesthetic profile with a substantially vertical blade construction which can be unobtrusively installed on most types of roofs, including residential roofs.

### BRIEF DESCRIPTION OF THE DRAWINGS

FIG. 1 is a side view of an example ventilation and electric generator system according to the invention.

FIG. 2 is a schematic view of an example electrical circuit section of the system.

FIG. 3 is a detailed drawing of an example generator of the system according to the invention.

FIGS. 4A and 4B are detailed drawings of an example magnet disc for the generator shown in FIG. 3 in plan and side view, respectively.

FIGS. 5A and 5B are detailed drawings of an example rotor disc for the generator of FIG. 3 in plan and side view, respectively.

FIGS. 6A and 6B are detailed drawings of an example generator stator disc in plan and side view, respectively.

### DETAILED DESCRIPTION

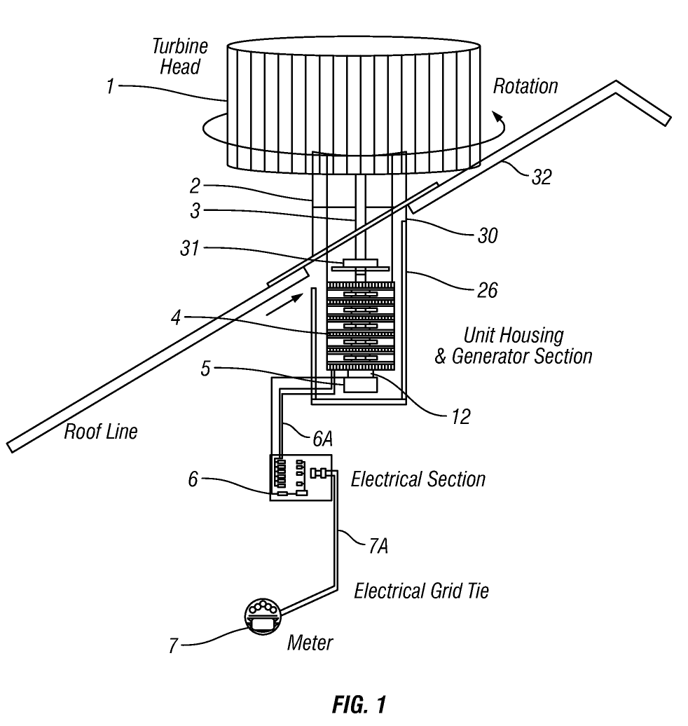

FIG. 1 shows an example turbine generator and ventilation system according to the invention. The example system includes a turbine head 1 rotatably connected to a through duct or conduit 2 and a connecting drive shaft 3. The conduit 2 may be configured to pass through a suitable opening 30 in a roof 32 such as may be at the top of a residential structure. The turbine head 1 converts wind energy into rotational energy, and the connecting shaft 3 transfers the rotational energy to a generator 4. The generator 4 further connects to a shaft speed measuring device (i.e., a tachometer) 12 and an electric motor 5. The generator 4 is connected to circuit sub section 6 with electrical wiring 6A. The electrical sub section 6 is connected to a meter and electrical grid 7 with electrical circuit wiring 7A. The system of the present invention may provide continuous ventilation in all wind conditions, including in low or zero wind conditions by using an electric motor 5 coupled to the shaft 3. The complete electric generation and ventilation system can provide various power output without stalling the turbine head 1 as a result of automatic switching on and off of stators (described in more detail below) that apply electrical load to the generator 4. The turbine head 1 may also pull air through the conduit 2 so as to ventilate the enclosed volume below the roof 30A. In some examples, the shaft 3 may be connected to the turbine 1 through a speed changing device, such as a planetary gear set 31. Using a speed changing device may enable using the generator/ventilator system according to the invention with different size turbines for specific applications, yet using a smaller number of different sizes of the generator 4, even as few as one size generator.

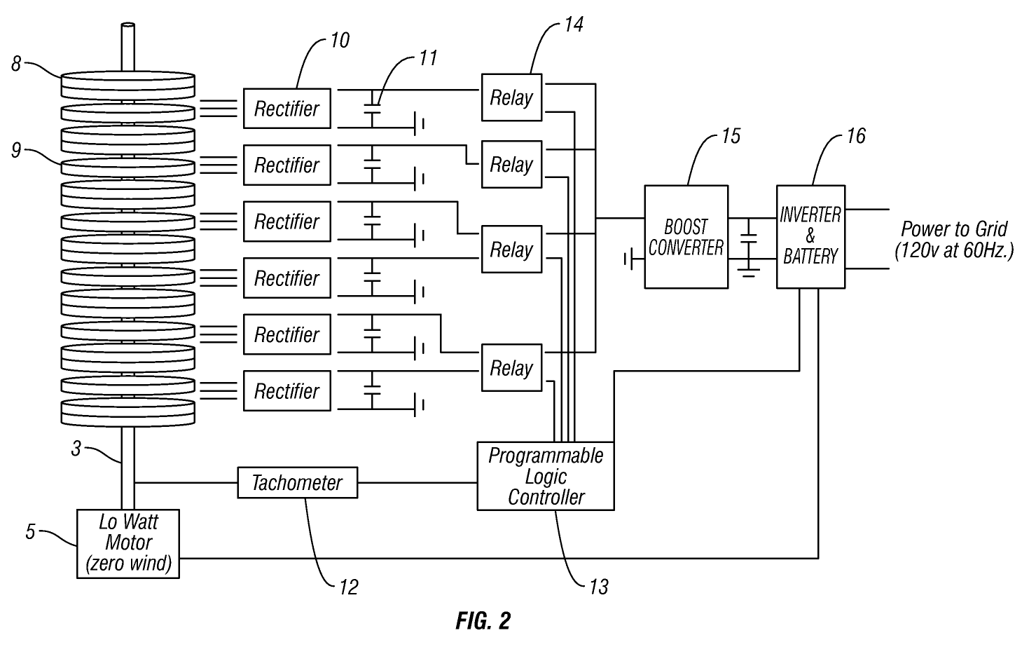

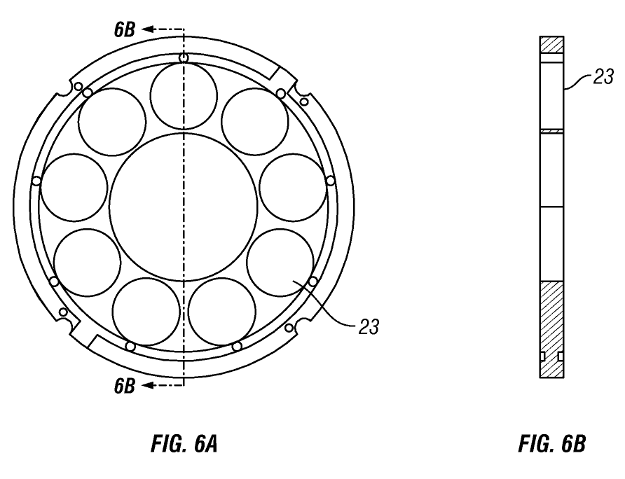

Still referring to FIG. 1, the generator 4 includes a selected number of magnetic rotor discs (8 in FIG. 2) and stator pairs (9 in FIG. 2) to convert rotational energy transferred by the shaft 3 into, for example three-phase alternating current in predetermined amount for the electrical sub system 6. Rotation of the turbine 1 is coupled by the connecting shaft 3 to turn the rotor disks (8 in FIG. 2). The number of rotor discs 8, each including a magnet pair 17 (explained below) and the number of stators 9 are selected to provide a desired electrical output from the generator 4. In one example, a selected number of the stators 9 may be automatically electrically coupled (using sub system 6 explained below) to an electrical load such as the power grid so that the turbine 1 may be rotated even by very low speed wind. Electrical load on the generator 4 may be automatically increased or decreased by electrically coupling more or fewer of the stators 9 to the electrical load. The rotors 8, each containing the magnetic disc pair 17, consisting of a magnet on each side thereof, create a high density magnetic field across the stator 9, and included wire coil (23 in FIG. 6A). The magnetic field from the magnet pairs 17 on each rotor disc 8 induces electric current in the coil (23 in FIG. 6A) on each stator 9. The combined voltage and current of all the stators 9 determines the maximum power output of the generator 4. The maximum possible power output at any moment in time is dependent on rotational speed of the shaft 3.

The electrical subsection in FIG. 1 is shown in more detail in FIG. 2. The electrical subsection 6 receives the current from the generator 4 and (in the case of an AC generator) converts it to direct current using rectifiers 10. There may be a rectifier 10 for each magnetic rotor disc 8 and stator pair 9. The number of rectifiers 10 may be determined by the number of rotor discs 8 and stator pairs 9. Direct current from each rectifier 10 may be connected to corresponding capacitor 11. Electrical loading of the rectifiers 10 and capacitors 11 may be turned on or off by a respective relay switch 14 connected to each capacitor 11 and rectifier 10. Each relay switch 14 may be controlled by a programmable logic controller (PLC) 13. As explained above, the power output of the generator 4 may be selected by selecting the number of stators 9 that are electrically connected to a load, in the present example by closing corresponding relay switches 14. The relay switches 14 may be operated by the PLC 13.

Signal input to cause the PLC 13 to operate the switches 14 in the present example may be provided by the tachometer (12 in FIG. 1). Whether to close any one or more selected switches 14 may be related to a preselected shaft (3 in FIG. 1) speed. Output from each of the rotor disc 8 and corresponding stator 9, having been converted to direct current and controlled by the PLC 13 may then be boosted to a predetermined voltage in a boost converter 15. The direct current may be inverted to single phase alternating current in an inverter/battery 16 and connected to 120/240 volt main line grid power through a meter 7 to measure the amount of electricity delivered back to the grid. The inverter/battery 16 supplies power for the PLC 13 should grid power become unavailable. The system may also be configured for off-grid supply of electricity.

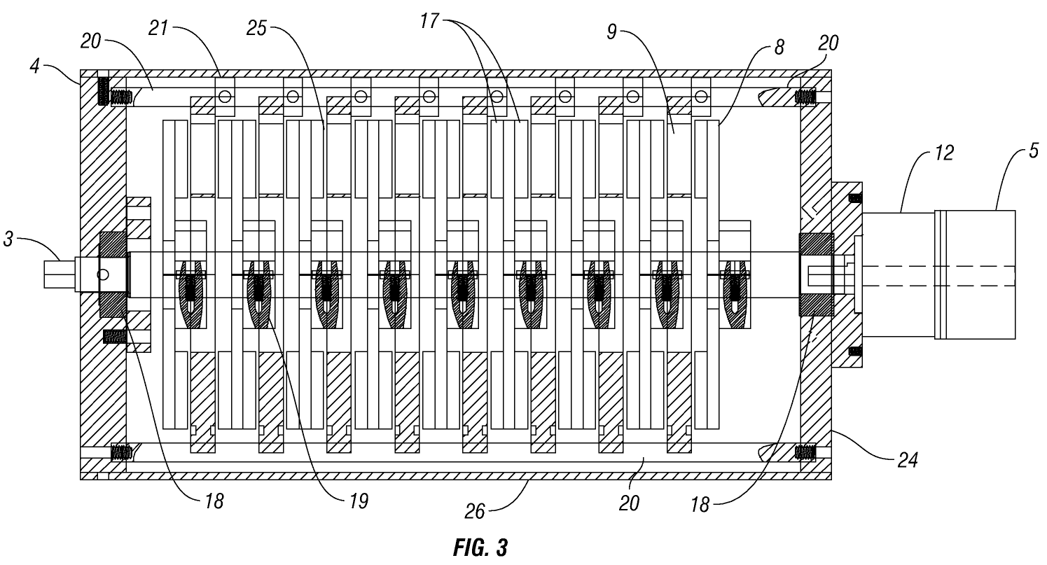

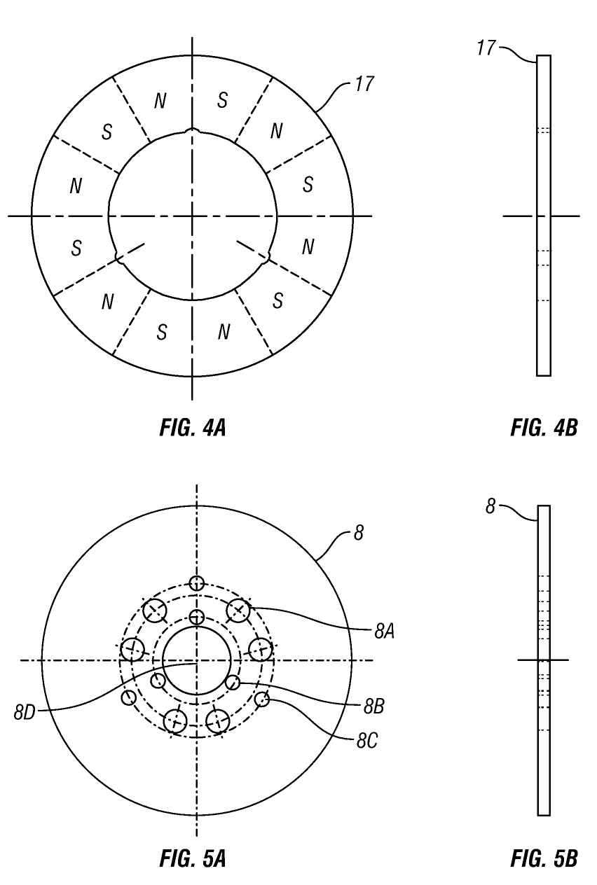

The construction details of the example ventilator generator system of the invention are shown in FIG. 3, FIGS. 4A and 4B FIGS. 5A and 5B, and FIGS. 6A and 6B. FIGS. 4A and 4B show a magnet disc 17 in plan view and side view, respectively. FIGS. 5A and 5B show one of the rotors 8 in plan view and side view, respectively. FIGS. 6A and 6B show one of the stators in plan and side view, respectively.

The system may be constructed of steel, stainless steel, aluminum or any material suitable for strength and machining capabilities. All machined parts may be, for example, computerized machine cut, to +/−0.002 inch tolerance. These tolerances may be varied to higher or lower tolerance. The stators 9 may be constructed of any suitable plastic with thermo-mechanical and strength properties that may be suitable for construction and machining The stators 9 may be machined from a larger amount of material than the dimensions of the finished stator or produced by plastic injection molding or other comparable process. The coils (23 in FIG. 6A, 6B) in each stator 9 may be constructed of wound copper wire or other electrical conducting material in sufficient geometrical proportions and quantity for the required power output, and may have suitable electrical insulation on the surface thereof. The coils 23 may be electrically connected by copper wire or other conducting material in series or parallel configuration, either together or apart to provide the desired electrical output from the generator 4. The rotors 8 and stators 9 may have through-hole penetrations to induce cooling by air movement through the rotors 8 and stators 9 as the rotors 8 turn. The coils 23 may be individually and previously formed or wound and placed or impregnated into the stator 9 in an arrangement such as the one shown in FIG. 6A. Other arrangements and geometry of the coils 23 in the stator 9 are possible. The magnet discs 17 may be constructed of Neodymium, Neodymium-Iron-Boron, ceramic, Samarium-Cobalt or any other high magnetic flux density permanent magnetic material. The magnet disc 17 is shown in detail in FIG. 4. The magnet discs 17 in the present example may be integrally formed rings (flat toroidal or “donut” shaped) made of the selected permanent magnet material. The magnet discs 17 may be bonded or otherwise affixed to the rotor 8, one on the top side of rotor 8 and one on the bottom side of rotor 8. The magnet material—Neodymium in the present example—is then magnetized with the magnetized poles permanently polarized into each ring, for example alternatingly, parallel to the rotational axis of the rotor 8, and in circumferential segments as shown in FIGS. 4A and 4B. Polarization can be the same on both the top and the bottom magnet discs 17 in exact placement to pass precisely over the coils (23 in FIGS. 6A and 6B) when assembled into the generator to maximize magnetic field strength and thus current induced into coils 23.

The magnetic discs 17 attached to the rotor 8 may be polarized in a specialized magnetic array, as explained above with reference to FIGS. 4A and 4B. Having the magnet discs 17 in the described double-sided arrangement, and with the exacting specifications explained herein above can provide that the path of the magnet discs 17 traveling over the coil 23 in the stator 9 (when affixed to the shaft 3 with shaft collar 19) is exactly positioned within 0.002 inches of the maximum flux density of the magnet disc 17 and rotor 8 combination. Magnet disc parallelism can be less than 0.002 inches tolerance. Due to the very high precision, the air gap 25 between magnet disc 17 and stator 9 is thus reduced to near zero. As a result the magnetic flux density available for energy conversion to electricity is at maximum. The magnet discs 17 are preferably arranged so that each disc is in exact magnetic polar alignment with each of the other discs 17. For example, beginning with a magnetic north (N) pole on the underside of the uppermost rotor disc (left side of FIG. 3) the next pole below the first stator 9 (moving to the right in the diagram) is in exact vertical alignment and is a magnetic south (S) pole. On the other side of the rotor 8, exactly in line with the S pole, is the next N pole. Configured as explained above, the overall energy conversion efficiency of the generator 4 can be maximized. An example rotor is shown in plan view and side view in FIGS. 5A and 5B, respectively. In FIG. 5A, a center hole 8D allows the shaft (3 in FIG. 1) to pass through. A shaft collar (19 in FIG. 3) affixes the rotor disc 8 to the shaft (3 in FIG. 1). The smallest three inner holes 8B may be used to attach the shaft collar (19 in FIG. 3) to the rotor disc 8, with, for example, machine screws. The outermost small holes 8C are alignment holes usable so that during polarization/fabrication of the rotor/magnet disc pairs the poles of all the magnet discs 17 will be correctly aligned, disc to disc. The six largest holes 8A on the rotor disc 8 are cooling holes so that air can pass from the bottom of the completed generator all the way through the top of the generator. Blades can be attached to the top end of the generator to enhance the pull of cooling air through the entire generator assembly. Ports may be provided in the outer housing (26 in FIG. 3) or holes may be provided in the end caps (24 in FIG. 3) to complete the air circulation path.

In further detail, and referring to FIG. 3, the generator 4 may include a number of additional components. The rotors 8 may be affixed to the shaft 3 with a shaft collar 19. The longitudinal shaft collar 19 position on the shaft 3 can be adjusted during assembly to maintain high precision and near zero air gap 25. The stator 9 can be connected to a frame-leg 20 with a stator affixing collar 21. The longitudinal position of the stator 9 is adjustable on the frame-leg 20 to maintain near zero air gap 25 during assembly. The frame-leg 20 can be affixed to end plates 24 at the top and bottom of the complete assembly. The end plates 24 can have openings for air circulation and cooling. The generator assembly 4 may be encased in a protective housing 26. The end plates 24 may be affixed to the housing 26 to secure the foregoing components within the interior of the housing 26. The shaft 3, rotors 8 and stators 9 may be held in place with a top and bottom bearing assembly 18. Each bearing assembly 18 can be constructed of steel, stainless steel, sealed, shielded or other bearing type. Attached near the bottom of the shaft 3 is the tachometer 12 used to measure shaft speed, and also attached to shaft 3 is the electric motor 5. The electric motor 5 is used to rotate the shaft 3 and the attached turbine (1 in FIG. 1) to induce ventilation at times when the wind speed is below a preselected threshold value programmed into the PLC (13 in FIG. 2). The threshold value is adjustable and may be selected based on turbine head 1 size and shaft speed in particular wind conditions.

With reference to the generator 4, the tachometer 12 and the electric motor 5 may be positioned at either the top or the bottom of the generator 4 (i.e., at either longitudinal end) and may also be incorporated within the generator 4 itself. The generator 4 can be located below the turbine head 1 inside an air shroud (e.g., conduit 2 in FIG. 1) or can be positioned inside the turbine head 1. The turbine head 1 can be of numerous designs, with straight or curved vertical blades, and with or without a domed top.

The advantages of the present invention may include, without limitation, that it is high output and slow speed with high energy conversion ratio that can be greater than 98 percent efficient. The generator can be scaled to fit a multitude of applications as a stand-alone generator or used in hydroelectric generation processes. The configuration can be used in residential or commercial building settings and of either new construction or retrofitted. The housing and bearings can be made air and water tight and the whole assembly 4 can be made to withstand pressure and prevent fluids from entering. The whole generator 4 assembly can be scaled from very small to very large. In broad principle, the present invention is a controlled wind driven multiple power output constant ventilation device typically mounted on a rooftop of a building.

While the invention has been described with reference to a limited number of examples, those skilled in the art will readily devise other examples that do not exceed the scope of what has been invented. The invention should therefore not be limited by the above described embodiment, method, and examples, but by all embodiments and methods within the scope of the attached claims.

What is claimed is:

1. An electric generator, comprising:
a plurality of magnet disks coupled to a rotating shaft at longitudinally spaced apart locations, the magnet discs formed on each face of a substantially flat, cylindrical rotor from magnetic material and polarized in a selected pattern;
a plurality of stators disposed between pairs of the magnet discs;
at least one wire coil disposed in each stator; and
a controller configured to selectively connect a selected number of the wire coils to an electrical load, the number selected based on a rotational speed of the shaft.

2. The generator of claim 1 wherein a magnetization of the magnet disks and a spacing between each magnet discs and an adjacent one of the stators results in the stators being disposed within at most 0.002 inches of a maximum magnetic flux of the magnet discs.

3. The generator of claim 1 wherein each magnet disc is magnetically polarized alternatingly in circumferential segments around the disk, the magnetic polarization substantially parallel to a rotational axis of the shaft.

4. A ventilation system, comprising:
a wind-driven turbine ducted to a volume to be ventilated;
an electric generator rotationally coupled to the turbine;
an electric motor rotationally coupled to the turbine;
a shaft rotation sensor rotationally coupled to the turbine; and
a controller coupled to the tachometer, the controller operatively coupled to a first switch to connect electrical output of the generator to a power grid in response to a signal from the shaft rotation sensor that rotation speed exceeds a selected threshold, the controller operatively coupled to a second switch to connect the motor to the power grid when the rotation speed is below the selected threshold.

5. The ventilation system of claim 4 wherein the generator comprises a plurality of magnet disks coupled to a rotating shaft at longitudinally spaced apart locations, the magnet discs formed on each face of a substantially flat, cylindrical rotor from magnetic material and polarized in a selected direction, a plurality of stators disposed between pairs of the magnet discs and a wire coil disposed in each stator.

6. The ventilation system of claim 5 wherein the controller is configured to connect a number of the wire coils to the power grid related to a rotational speed of the shaft.

7. The ventilation system of claim 5 wherein the generator comprises:
a plurality of magnet disks coupled to a rotating shaft at longitudinally spaced apart locations, the magnet discs formed on each face of a substantially flat, cylindrical rotor from magnetic material and polarized in a selected pattern;
a plurality of stators disposed between pairs of the magnet discs; and
a wire coil disposed in each stator.

8. The ventilation system of claim 7 wherein a magnetization of the magnet disks and a spacing between each magnet discs and an adjacent one of the stators results in the stators being disposed within at most 0.002 inches of a maximum magnetic flux of the magnet discs.

9. The ventilation system of claim 7 wherein each magnet disc is magnetically polarized alternatingly in circumferential segments around the disk, the magnetic polarization substantially parallel to a rotational axis of the shaft.

10. The ventilation system of claim 5 further comprising a speed changing device disposed rotationally between the turbine and the shaft.

11. The ventilation system of claim 10 wherein the speed changing device comprises a planetary gear set.
